(19) United States
(12) Patent Application Publication
(10) Pub. No.: US 2004/0161152 A1
(43) Pub. Date: Aug. 19, 2004

(54) Automatic natural content detection in video information

(76) Inventors: Matteo Marconi, Buttapietra-Verona (IT); Paola Carrai, Monza (IT); Giulio Ferretti, Milano (IT)

Correspondence Address: Corporate Patent Counsel, Philips Electronics North America Corporation, P O Box 3001, Briarcliff Manor, NY, 10510, US

(21) Appl. No.: 10/480,126

(22) PCT Filed: Jun. 14, 2002
(86) PCT No.: PCT/IB02/02279

(30) Foreign Application Priority Data
Jun. 15, 2001 (EP) 012022794

(51) Int. Cl. G06K 9/46; G06K 9/34

(52) U.S. Cl. 382/190; 382/173

(57) ABSTRACT

A method of distinguishing areas of natural and synthetic content in video information represented by pixels arranged in a matrix of lines is disclosed. A luminance histogram (hist(L)) of pixel values for each line of the matrix is created. The distances (d) between each of the histogram values for each line are then determined. A line is classified as containing natural content if the majority of distances (d) is less than or equal to a predetermined value. Neighboring lines containing natural content are then grouped together to create groups of natural content. The process can then be repeated a predetermined number of times to more precisely define areas with natural content.

### FIELD OF THE INVENTION

The invention relates to a method, device and apparatus for distinguishing areas of natural and synthetic content in video information.

### BACKGROUND OF THE INVENTION

CRT monitors are characterized on one side by a higher resolution than television screens and, on the other side, by a lower brightness. This is due to the fact that originally the content displayed on computer monitors was exclusively synthetic, and in particular, it was represented by text. This type of content clearly needs a high resolution to be enjoyable to the user but this causes a decrease in brightness.

The situation today has changed greatly. The Internet and multimedia technologies, such as DVD, and image storage and transmission, have caused an increase in the amount of natural TV-like content in monitor applications. This new situation has caused a series of problems for monitors because the monitors were not originally designed for such content.

The basic idea for new-concept CRT monitors is that the monitors should be adaptable to the content of an image that in a particular moment is displayed. An example is to apply video-enhancement algorithms to the natural content in order to obtain a significant improvement in the quality of natural images displayed on the monitors. However, if these video-enhancement algorithms are applied to pure text or graphics, the overall result is a significant loss in image quality. From this point of view, the ability to distinguish between natural and synthetic content becomes important.

Enhancement solutions are known that can improve significantly visual performances, if applied to specific areas of the screen in which natural contents are present. Window-based (which is application based) manual selection performed by the user is a simple though boring method for identifying these areas, which can be adapted when the whole window content is natural content. Unfortunately, the same approach cannot be used in cases where composite contents are in the same window, as is typical of Web pages, because, as noted above, application of the video-enhancement algorithms to the pure text or graphics can cause significant loss in their perceived visual quality. Thus, there is a need for a method, device and apparatus for distinguishing between natural and synthetic content before the content is displayed on a monitor.

### SUMMARY OF THE INVENTION

It is an object of the invention to overcome the above-described deficiencies by providing a method, a device and apparatus for automatically distinguishing natural content from synthetic content using only the raw screen data of the image. The invention is defined by the independent claims. The dependent claims define advantageous embodiments.

According to an embodiment of the invention, the natural image content is distinguished from the synthetic image content by means of a statistical analysis aimed at extracting some features from an image and then performing a smart interpretation of the features. One of the advantages of this method is the extremely low computational complexity achieved by locating all of the “intelligence” in the analysis of the extracted feature instead of in the analysis of the image.

In case of video information, the video information is handled as a sequence of images, each of which are processed independently. In the first step of the method, the video information is analyzed. As next step neighboring sections of the video information which contain similar features found during the analysis are then grouped together. Sections can be lines of rows or columns of the image, but can also be parts of lines. Finally, groups which have a first feature are designated as being natural content and any remaining groups are designated as being synthetic content.

It is advantageous if a luminance histogram of pixel values for each line of the matrix is created. The distances between each of the non-zero histogram values for each line are then determined. A line is classified as containing natural content if the majority of distances is less than or equal to a predetermined value. Neighboring lines containing natural content are then grouped together to create groups of lines with natural content.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1(a) illustrates a block diagram of a general algorithm philosophy;

FIG. 1(b) illustrates a block diagram of an algorithm according to the invention;

FIGS. 2(a)-(c) illustrate a luminance histogram analysis of a synthetic case according to the embodiment of the invention;

FIGS. 3(a)-(c) illustrate a luminance histogram of a middle synthetic case according to the embodiment of the invention;

FIGS. 4(a)-(c) illustrate a luminance histogram analysis of a natural case according to the embodiment of the invention;

FIG. 5 illustrates a data tree for storing information related to coordinates of target areas according to the embodiment of the invention;

FIG. 6 is a representation of a number of sub-areas extracted from the target areas according to the embodiment of the invention;

FIGS. 7-10 illustrate screen shots which will be used to describe an illustrative example of the invention;

### DETAILED DESCRIPTION OF THE INVENTION

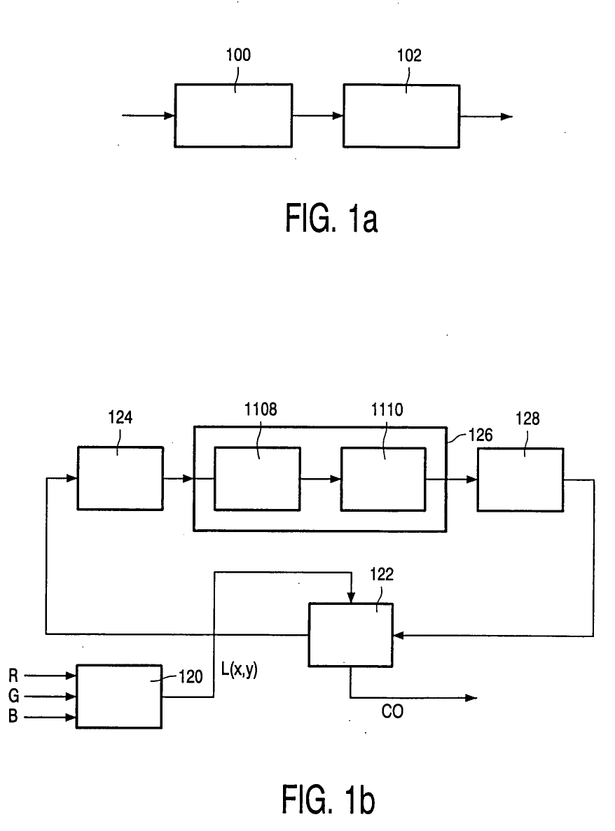

The invention can be regarded as a mix of segmentation and recognition. Many problems of signal recognition have been posed and solved in literature and then in applications, but most of them referred to mono-dimensional signals. Although these proposed solutions are very different, if a general analysis is done of all of them, some similarities can be pointed out. In fact most of these proposed solutions present a similar general structure which is illustrated in FIG. 1 (a). First of all, a feature extraction block 100 that performs the so-called “feature extraction” is present, followed by a feature analysis block 102 that performs the “feature analysis”. Obviously, this description represents a very general abstraction because the term “feature” can mean many different objects. However, a key idea of the invention is that the “intelligence” of the algorithm has to be posed in the feature analysis block 102 which does not operate on the original data, but rather on a filtered (condensed) version of the original data. Original data could be corrupted from noise or extra information not useful or dangerous for the recognition. Features, instead, are regarded as a filtered version of data (in a general sense) which contain only the essential information.

From these considerations, several observations can be drawn. First, most of the intelligence of the algorithm is concentrated in the feature analysis block 102. Second, on the contrary from the previous observation, the most resource consuming part is usually the feature extraction block 100, since in general, original data require, for example, larger memories for storing the data than extracted features. Finally, feature extraction is the most critical phase. In fact, it is critical to find extracted features, which really contain information needed for the feature analysis.

FIG. 1(b) illustrates a system for implementing one embodiment of the invention. The system comprises a luminance conversion unit 120, a controller 122, a histogram evaluator, 124, a classification unit 126 comprising an analyser 1108 and a rule application unit 1110 and a coordinate extractor 128. The operation of the system is described below.

In case the luminance values L(x, y) of the matrix of pixels in the image are not available but the values of the red, green and blue color components are, then the luminance conversion unit 120 provides the required conversion as explained below.

Since it is very well known that luminance contains the biggest part of the information about shapes, it is important to use this parameter for the processing. In literature, luminance is provided by the following formula:

L(x, y)=(0.2989*R(x, y)+0.5870*G(x, y)+0.1140*B(x, y)) with L,R,G,B

in [0,1]. R,G,B being the red, green and blue color components of the pixel in the array with coordinates x, y.

A simplified version that avoids floating point operation (when L,R,G and B are in the range [0,255] as will be assumed in the further explanation of this embodiment) is

$$L ( x , y ) = \frac{( 77 R ( x , y ) + 150 G ( x , y ) + 29 B ( x , y ) ) ( integer division )}{256}$$

Histograms of the luminance values L(x, y) are evaluated in the histogram evaluator 124 as described below. A key idea is to evaluate the mono-dimensional histograms of the luminance values L(x, y) of every row of the image separately. The same kind of elaboration is iterated on the columns to obtain an additional set of histograms.

An important assumption of this embodiment of the invention is that areas to be recognized are rectangular in shape. It has to be noticed that this approach includes implicitly this geometric assumption in the disclosed method. In fact, analyzing rows and columns separately results in the image being analyzed only in the horizontal and vertical directions but the invention is not limited thereto.

From a computational point of view, the processing of the luminance values L(x, y) is the most resource consuming. It is necessary to scan the whole image pixel by pixel. However, as noted above, the objective is to analyze the whole image to obtain a set of features less numerous than the luminance data of the whole image.

A key idea behind the classification unit 126 is to classify lines (being rows or columns) as natural image, if the corresponding histograms are peculiar for a natural image. From experimental tests, it has been noticed that histograms relating to a natural image have different characteristics compared to a histogram related to a synthetic image. These characteristics are composed of distances d that occur between consecutive non-zero elements of the luminance histograms L(x, y).

The analyser 1108 analyses these distances d, making use of a distance histogram hist(d) of these distances. A key idea in this analysis is that in case a significant amount of natural image is present in the line, small distances are more probable than large distances. A classification rule is then used in the rule application unit 1110 to classify lines based on these distances.

A clear-cut separation between distance histograms hist(d) representing natural content and those representing synthetic content is obtained using the following rule:

### CLASSIFICATION RULE

$$IF arg \{ max ( hist ( d ) ) \} = 1$$

### THEN NATURAL

### ELSE SYNTHETIC

As mentioned before, it is assumed that there is a range [0,255] of luminance values, hence the possible distances range from 1 to 255. The function

$$arg \{ max ( hist ( d ) ) \}$$

extracts the distance (or distances), which satisfy the condition inside the parenthesis. In this case it extracts the distance (or distances) corresponding to the absolute maximum value of hist(d) (or maximum values if there are two or more equally large maximums).

Whenever there are two or more distances d found, which satisfy the condition, then the smallest distance d is used in the classification.

If the distance one is the most frequent distance in the line (so resulting in a maximum of hist(d) at d=1), then that line is considered to be containing a significant amount of pixels belonging to a natural image and therefore the line is classified as NATURAL, otherwise it is classified as SYNTHETIC. In this way, distance equal to one is considered to represent a line with natural content while all other distances are considered to represent lines with synthetic content. It will be understood that the invention is not limited to just this one rule and that the distance which delineates between natural and synthetic content can have values other than one. For example, a fuzzy approach could be used to take into account other small distances and use for example more classes like: “probably synthetic”, “probably natural”, “very likely natural”.

Once all lines (rows and columns) are classified, neighboring lines classified as NATURAL are grouped together. This grouping of lines uses in a preferred embodiment as rule that if less than three consecutive SYNTHETIC lines are present in between NATURAL lines, then these SYNTHETIC lines are included in the group of neighboring lines classified as NATURAL. Alternatively the rule may use more or less than the mentioned 3 lines. Moreover, the rule discards groups which comprise less than a predetermined number of natural lines. This predetermined number can be one, but larger numbers are also possible.

As next step areas formed by the cross-sections of groups of row-lines and groups of column-lines are determined. These areas are the likely NATURAL areas of the image. The coordinate extractor 128 determines the coordinates of the corners of these areas. These coordinates are fed back to the controller 122. The controller 122 then determines whether the process of determining the NATURAL area should be repeated for a specific area. If yes, the steps indicated in FIG. 1b by the blocks 124, 126, 128, 122 is repeated for these specific NATURAL areas of the image. This repetition is done preferably on a slightly larger area to secure that this larger area encloses the actual NATURAL area of the image.

After a number of cycles, resulting in a more accurate determination of the NATURAL areas, the controller 122 delivers the final values of the coordinates of the corners of the NATURAL areas.

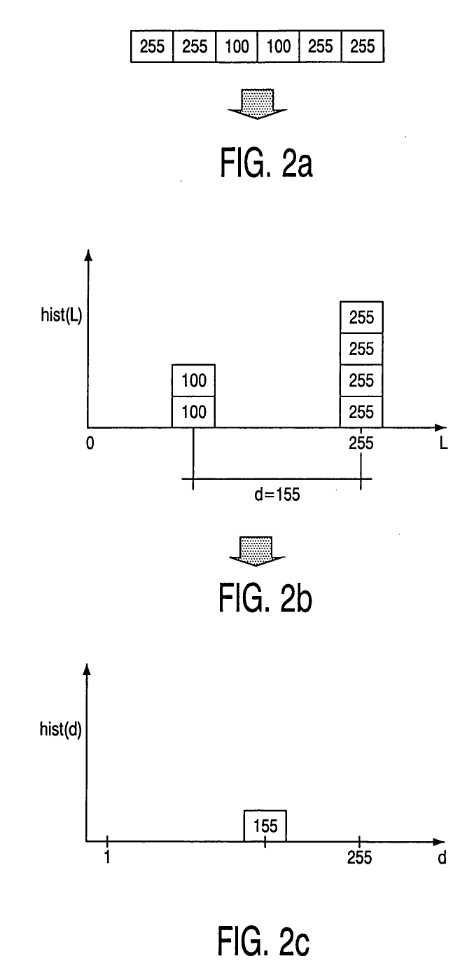

In FIGS. 2, 3, and 4, the algorithm just described is evaluated in three different (and simplified cases). FIGS. 2(a)-(c) illustrate an extremely synthetic case, in which in FIG. 2(a) a uniform line (simulated with two pixels having a value of 100) is plotted on a constant background (simulated with pixels whose values are 255). As illustrated with the luminance histogram hist(L) in FIG. 2(b), the distances d between the luminance values of the pixels present in the line is 155. As can be noticed in this case, no distances d equal to one are present in the distances histogram hist(d) and distances tend to have great values as expected for lines whose content is synthetic.

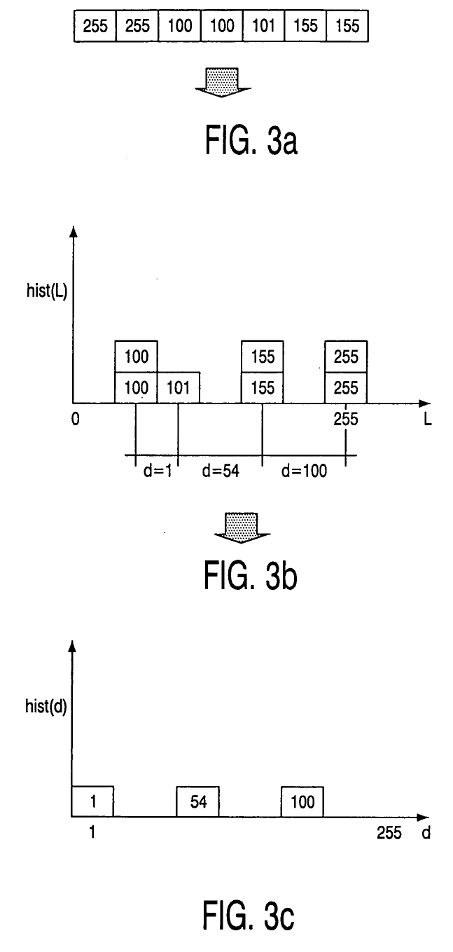

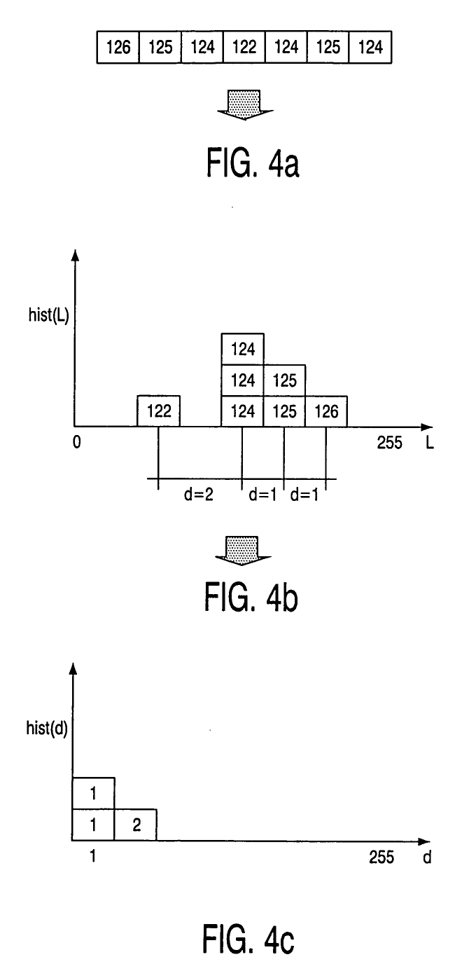

FIGS. 4(a)-(c) illustrate a “natural” case. Here, the line of FIG. 4(a) being analyzed contains softened values that are typical of natural images. In this example, the pixel values are grouped between 122-126 and the distances equal 2, 1, 1, respectively as shown in the histogram hist(L) in FIG. 4(b). As a consequence, small distances are more numerous than the others and therefore the classification rule results in classifying the line as natural. FIGS. 3(a)-(c) illustrate an intermediate case in which both clear cut values and softened value are present. In this example, some of the pixel values are grouped around 100 while other pixel values equal 155 and 255 as shown in FIG. 3(a). The resulting distances equal 1, 54, 100, respectively as shown in the histogram hist(L) in FIG. 3(b). In this case, both distances d equal to one and different from one are present, but since distances d different from one are not more numerous than the distances d equal to one as shown in hist(d) in FIG. 3(c), the line is classified as natural.

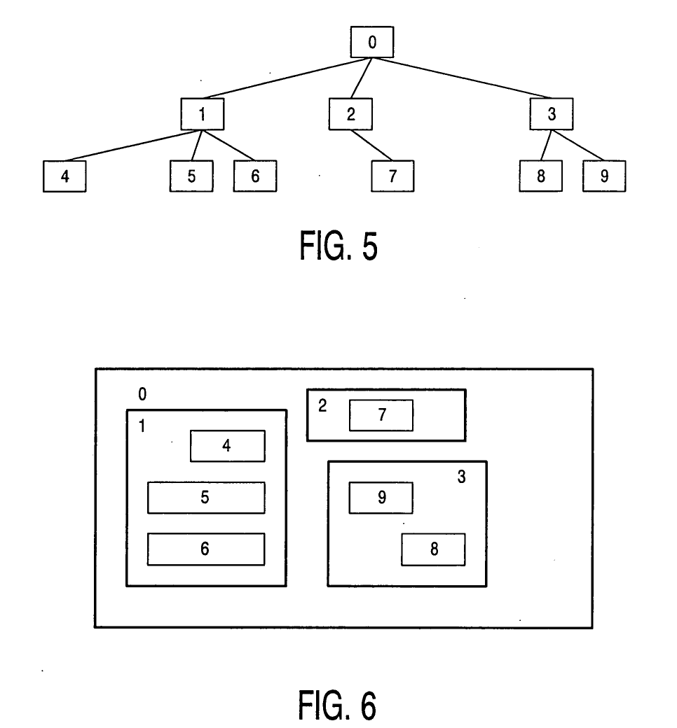

As illustrated in FIG. 5, a tree is used as a data structure to store information related to coordinates found and the classifier 126 is used on the images extracted in the previous cycle. First of all, the classifier 126 is used on the entire image extracting a list of 4×m coordinates relative to the areas in which it is more probable the presence of an image (where m is the number of target areas). Then, the classifier is restarted on each of these target areas extracting a number of sub-areas in which images could be present, as illustrated in FIG. 6. This recursive process is repeated a number of times. It is experimentally obtained that repeating the process three times, delivers good results. The number of cycles could be dependent on a rule to stop iterations, for example, when having at the end of a cycle no or only one natural area inside the area that was evaluated during that cycle.

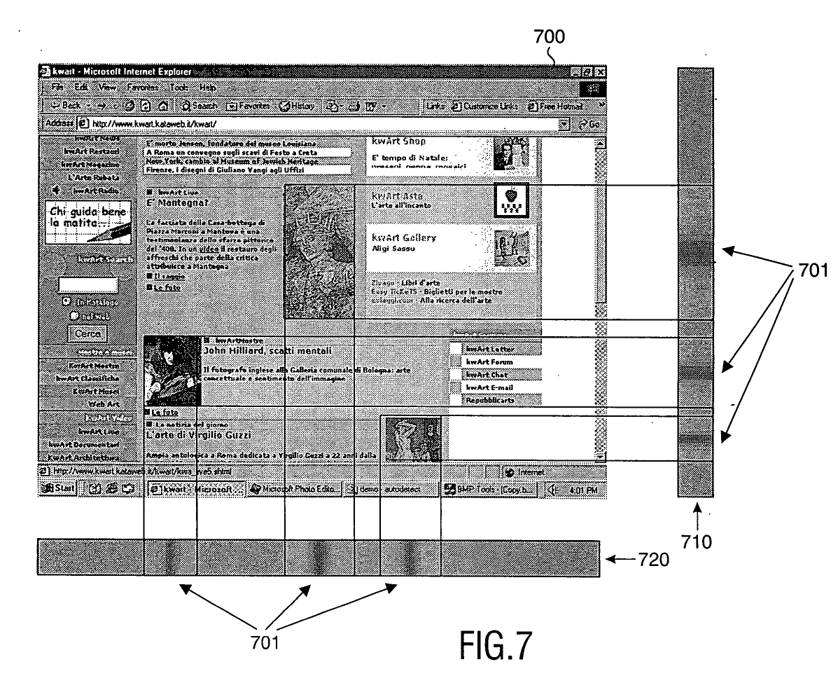

FIGS. 7-10 illustrate screen shots which will be used to describe an illustrative example of the invention. FIG. 7 illustrates the histogram evaluator 124 and classification unit 126 of this illustrative example. The histograms for the rows and columns of the screen 700 are evaluated separately for each row (as shown symbolically in a row bar 710) and column (a shown symbolically in a column bar 720). The most likely distance between a histogram value and the nearest value different from zero is found. If the most likely distance found is equal to one, that row (or column) 701 is considered to contain some natural content. Consequently, it is labeled as a probable row (or column) with natural content. At the end of this step, there are two vectors containing the classification of the rows and columns previously analyzed.

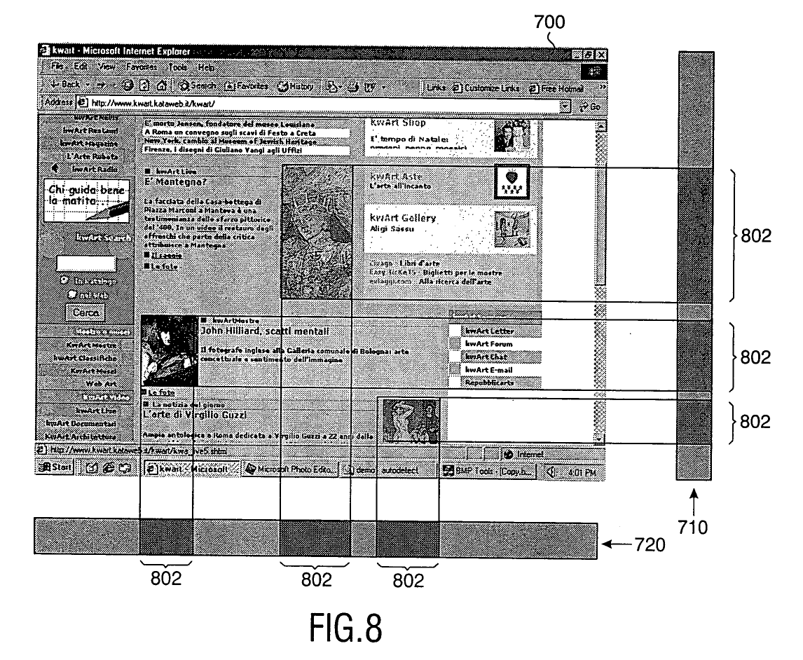

In the next step, a “regularization” of the classification of rows and columns contained in the vectors is performed, as illustrated in FIG. 8. With the term “regularization”, the aggregation of rows and columns labeled as natural content is meant. Rows (or columns) which have a distance between each other which is less than a predetermined threshold are considered to comprise information of the same natural image and are aggregated together as illustrated by blocks 802. In other words, the rows and columns as natural content are aggregated together according to their “density”.

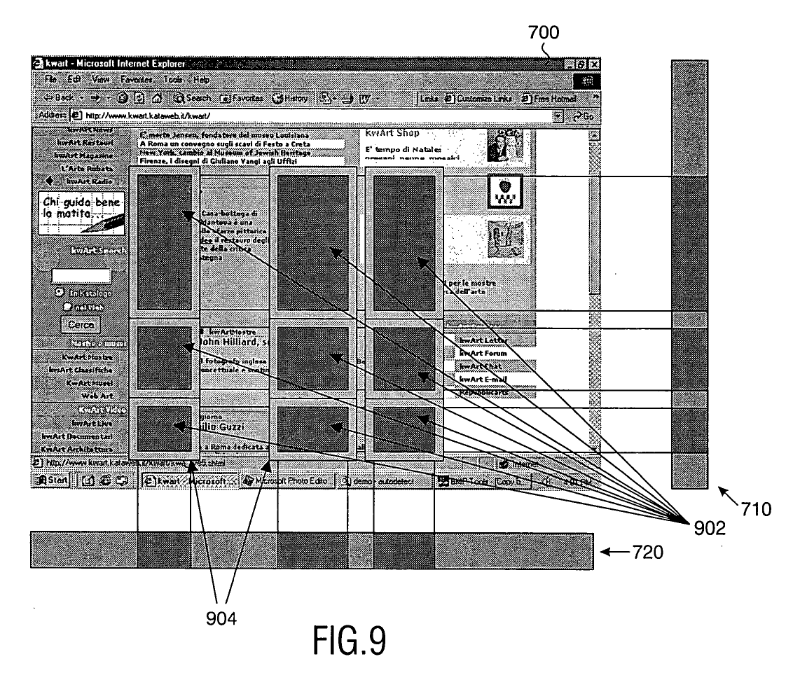

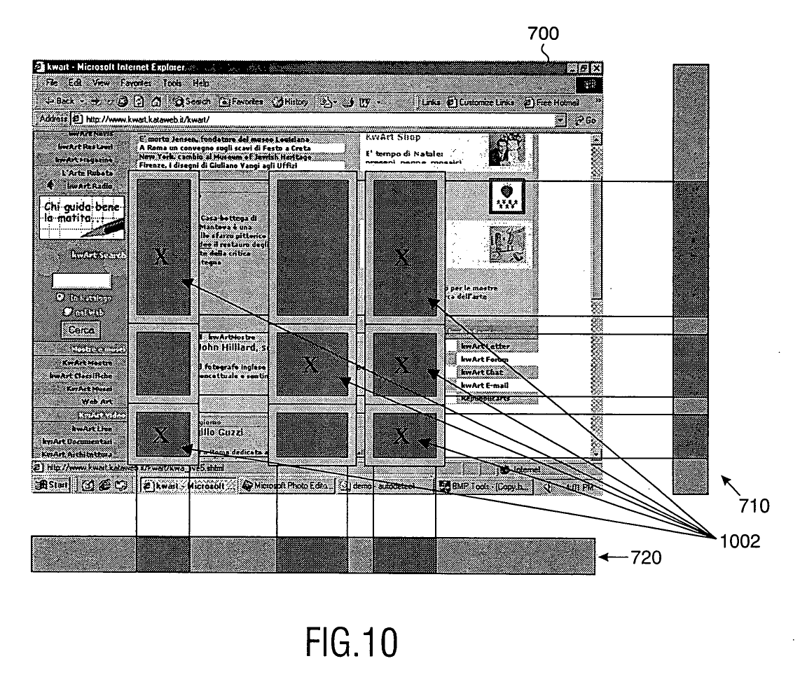

At this stage, the position of areas 902 with natural image content are identified as the cross-sections of the aggregated rows and columns as shown in FIG. 9. The position of these areas 902 is known from the two vectors. However, this position is not precisely known. Therefore, as next step each area of the image is evaluated separately. Larger areas 904 are considered in this step with respect the areas detected in the previous step, to take into account that detection, made previously, is quite rough. On these larger areas 904, the whole process of histogram evaluation 124, classification 126 and regularization is applied recursively. The advantage is that the histograms are evaluated on more specific areas and so their statistical content is more homogeneous. At the end of the recursion step, areas 904 which have rows and columns which do not meet the requirements for “natural content” are discarded. The resulting areas 1002 with natural content are illustrated in FIG. 10.

Another way to describe the classification unit 126 is given below. A distance probability function (DPF) can be determined, using the output of the histogram evaluator 124 in FIG. 11. The “Distances' Probability Function” (DPF) is calculated in analyser 1108. Given the luminance histogram hist(L) of the current line, the DPF P[d=k] is the frequency of finding a distance d between two consecutive non-zero elements equal to k. It is calculated as follows for each line i. Starting from the histogram of the line i, indexes of all the elements different from 0 are stored in a vector ρᵢ

ρᵢ={j|hᵢ(j)≠0, 0≦j≦255},

where hᵢ(j) is the j-th value of the luminance histogram for line i. This value represents the number of pixels in the line i that have a luminance equal to j. Whenever there is only one luminance in a line, the line is classified as Synthetic and the rest of the steps for that line are skipped. Else, differences between each pair of consecutive non-zero values, representing the distance δᵢ in terms of gray levels between non-zero elements of the histogram, are calculated (with j_{N} an index for the non-zero values):

δᵢ(j_{N})=ρᵢ(j_{N}+1)−ρᵢ(j_{N}), 0≦j_{N}≦(length(ρᵢ)−2),

Based on distances δᵢ the distance histogram h_{δi} is calculated and the DPF, for line i obtained as follows:

$${DPF}_{i} ( k ) {=}^{△} \frac{{h}_{{δ}_{i}} ( k )}{{\sum }_{n = 1}^{255} {h}_{δ i} ( n )} , 0 \leq k \leq 255.$$

A key idea is that in case the current line i contains a portion of a natural image, small distances in vector δᵢ are more probable than large distances. As a consequence, simplifying this approach, if DPFᵢ(k) is maximum for k=1, then that line is classified as NATURAL, otherwise it is classified as SYNTHETIC in the classification unit 126. In synthesis the classification rule is:

### CLASSIFICATION RULE

FOR LINE i
IF {k | DPFᵢ(k)≧DPFᵢ(j), ∀j≠k k,j∈[1,255]}=1
THEN LINE i → NATURAL,
ELSE LINE i → SYNTHETIC.

In a practical application the equal denominator

$${\sum }_{n = 1}^{255} {h}_{δ i} ( n )$$

both DPF functions can be deleted, when comparing DPFᵢ(k) and DPFᵢ(j). Likewise the separate calculation of the vector δᵢ can be deleted by deriving h_{δi} directly from hᵢ. It will be understood that other more sophisticated classification rules can be used for this purpose using the whole information contained in the DPF function instead of looking only at its maximum.

It will be understood that the different embodiments of the invention are not limited to the exact order of the above-described steps as the sequence of some steps can be interchanged without affecting the overall operation of the invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of distinguishing areas of natural and synthetic content in video information, comprising the steps of:
analyzing the video information;
grouping together neighboring sections of the video information which contain similar features found during the analysis;
designating groups of neighboring sections which have a first feature, as being natural content, and designating any remaining groups as being synthetic content.

2. The method according to claim 1, wherein the neighboring sections are cross-sections of rows and columns of the video information which contain similar features.

3. The method according to claim 1, wherein the analyzing step comprises the steps of:
determining luminance histogram values of pixels in a row, respectively a column; and
determining distances between non-zero histogram values within a histogram;
wherein the first feature is that a majority of the distances are less than a predetermined threshold.

4. The method according to claim 3, wherein the predetermined threshold is equal to two.

5. The method according to claim 1, further comprising the step of:
reanalyzing groups which likely contain natural content a predetermined number of times to more clearly define boundaries of the groups.

6. The method according to claim 5, wherein the boundaries of a group are defined by row and column coordinates.

7. The method according to claim 5, wherein the predetermined number of times is equal to three.

8. The method according to claim 1 wherein the information is represented by pixels in a matrix of lines of rows and columns and the analyzing comprises:
(a) creating a luminance histogram of pixel luminance values for each line of the matrix;
(b) determining distances between consecutive luminance histogram values for each line;
(c) calculating a distance probability function for each line from the determined distances; and
the first feature is that the distance probability has a maximum below a predetermined distance value.

9. The method according to claim 8, wherein the classification rule is:
FOR LINE i
IF {k | DPFᵢ(k)≧DPFᵢ(j), ∀j≠k k,j∈[1,255]}=1
THEN LINE i → NATURAL,
ELSE LINE i → SYNTHETIC.

10. A device for distinguishing areas of natural and synthetic content in video information, comprising:
means for analyzing the video information
means for grouping together neighboring sections of the video information which contain similar features found during the analysis;
means for designating groups of neighboring sections which have a first feature as being natural content, and designating any remaining group as being synthetic content.

11. An apparatus for distinguishing areas of natural and synthetic content in video information represented by pixels arranged in a matrix of lines, comprising:
means for creating a luminance histogram of pixel values for each line of the matrix;
means for determining the distances between each of the histogram values for each line;
means for calculating a distance probability function for each line from said determined distances;
means for classifying a line as containing natural content if the distance probability function has a maximum below a predetermined distance value; and
means for grouping together neighboring lines containing natural content to create clusters of natural content.
